(19) United States
(12) Patent Application Publication
(10) Pub. No.: US 2007/0068786 A1
(43) Pub. Date: Mar. 29, 2007

(54) TOUCH PAD HAVING INTEGRATED LIGHTING FEATURE AND TOUCH SENSOR AND METHOD OF OPERATING THE SAME

(75) Inventor: David A. Hein, Sterling Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,736

(22) Filed: Sep. 21, 2005

(51) Int. Cl. H01H 1/56

(52) U.S. Cl. 200/510

(57) ABSTRACT

A touch pad having an integrated lighting feature and touch sensor and method of controlling the same. The integrating lighting feature and touch sensor having a common electrical connection. The method of controlling the same including determining activation as a function of influences on the operation of the touch sensor.

### BACKGROUND OF THE INVENTION

1. Field of the Invention

The present invention relates to integrated lighting feature and touch sensor and method of operating the same.

2. Background Art

An integrated lighting feature and touch sensor is a device having a common electrical connection between the lighting feature and touch sensor. An electroluminescent (EL) light is one such lighting feature which may be arranged to share an electrode with a touch sensor, typically a capacitive or field effect technology (FET) device.

The use of an EL light with a touch sensor, such as on a touchpad, allows for a uniform distribution of light while providing integrated switch operability. This type of device may be used in automotive environments and other applications where it may be desirable to provide a range of switch sizes and shapes, and optionally, to facilitate the elimination of gaps and part lines in a dashboard or other feature associated therewith.

### SUMMARY OF THE INVENTION

One non-limiting aspect of the present invention relates to a method of determining switch activation for an integrated touch pad having a touch sensor and lighting feature. The method may include actively driving the lighting feature and sensing activation of the touch pad without interrupting driving of the lighting feature.

The method may further include monitoring capacitance associated with the touch sensor and determining activation of the touch pad as a function thereof.

The method may further include driving the lighting feature with a low frequency signal and superimposing a high frequency signal thereover for use in sensing activation of the touch pad. Optionally, the method may further include exposing the lighting feature and touch sensor to a low pass filter in order to limit interference with the high frequency signal, such as b configuring the low pass filter to be a RL low pass filter.

The method may further include isolating a power source associated with driving the lighting feature from the lighting source and touch sensor so as to limit interferences in sensing activation of the touch pad, such a by providing a transformer for isolating the power source from the lighting source and touch sensor.

The method may further include providing an additional touch sensor and sensing activation of the touch pad as a function of signals associated with both touch sensors.

One non-limiting aspect of the present invention relates to a method of determining switch activation for an integrated touch pad having a touch sensor and lighting feature. The method may include driving the lighting feature with a low frequency signal, providing a high frequency signal to the touch sensor, and sensing activation of the touch pad as a function a capacitance change sensed with the high frequency signal.

The method may further include superimposing the high frequency signal over the low frequency signal, and optionally, filtering the low frequency signals relative to the high frequency signal to limit interference when sensing activation of the touch pad.

The method may further include isolating a power source associated with driving the lighting feature with the low frequency signal from the lighting source and touch sensor so as to limit interferences in sensing activation of the touch pad.

One non-limiting aspect of the present invention relates to a touch pad system. The touch pad system may include a lighting feature configured to emit light when driven, a touch sensor configured to share a common electrical connection with the lighting feature such that the lighting element and touch sensor form an integrated lighting feature and touch sensor, a logical element to determine activation pad as a function of signals associated with the touch sensor, and a feature to limit interference associated with driving of the lighting feature from unduly influencing sensing activation of the touch sensor.

The feature may be a filter configured to isolate a first signal used to drive the lighting feature from a second signal used to facilitate determining activation of the touch pad, such as a low-pass RL filter. Alternatively, the feature may be transformer configured to isolate a power source used to drive the lighting feature

The touch pad system may include an additional touch sensor for use in determining activation as a function of influences on both touch sensors.

The touch pad system may include an automotive module in communication with the logical element and configured to be controlled according to signals received from the logical element in response to activation of the touch pad.

The touch pad system may include a decorative cover to facilitate mounting to a dashboard of an automobile having the automotive module.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrate an integrated touch pad in accordance with one non-limiting aspect of the present invention;

FIG. 2 illustrates a cross-sectional view of the touch pad in accordance with one non-limiting aspect of the present invention; and

FIG. 3 illustrates a schematic diagram of an arrangement for sensing activation of first and second touch pads in accordance with one non-limiting aspect of the present invention.

### DETAILED DESCRIPTION OF THE PREFERRED EMBODIMENT(S)

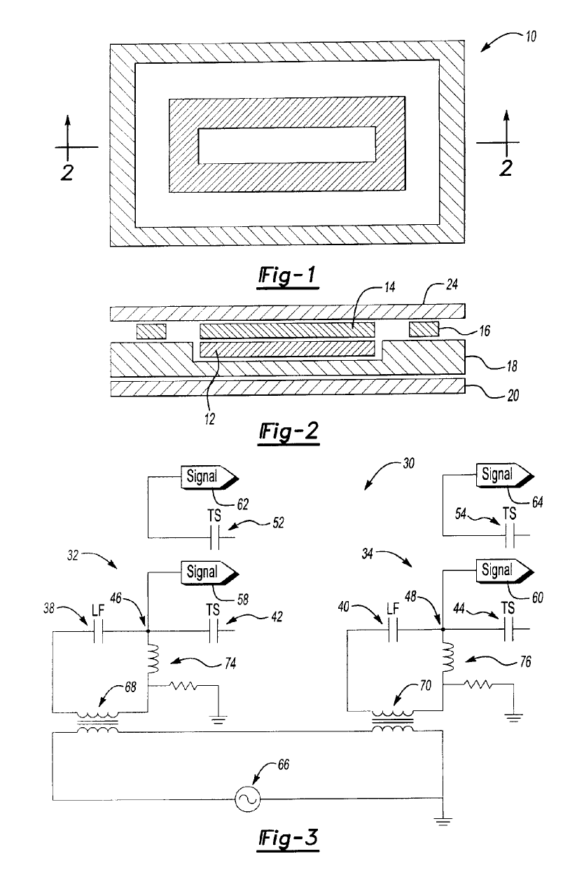

FIG. 1 illustrate an integrated touch pad 10 in accordance with one non-limiting aspect of the present invention. The touch pad 10 is intended to operate in environments where it is desirable to provide switching applications. The touch pad 10 may be used in any number of environments, including automotive electronic applications, such as in steering wheel and headliner applications wherein switching operations are desired for speed control, vanity mirror illumination control, door lock control and performing a number of other operations

FIG. 2 illustrates a cross-sectional view of the touch pad 10 in accordance with one non-limiting aspect of the present invention. The touch pad 10 may include a lighting feature 12 and first and second touch sensors 14-16 positioned proximate the lighting feature 12. The lighting feature 12 may relate to an electroluminescent (EL) light or other feature having suitable characteristics to support lighting operations, such as those suitable for thin-film or other low-profile operations.

The first and second touch sensors 14-16 may be positioned proximate the lighting source 12 and used to sense user interaction with the touch pad 10. The touch sensors 14-16 may be capacitive, field effect, or other suitable features having properties sufficient to detect encroachment of a user's finger or other conducting item towards the touch pad. A microprocessor (not shown) or other logically functioning element may receiving signals or interface with other features of the touch sensors 14-16 to determine whether the user interaction is intended to reflect a desire to activate a switching operation associated with the touch pad 10.

The ability of the touch sensors 14-16 to sense user interaction with the touch pad 10 without requiring a user to mechanically depress a switch or perform other physical actuations may be advantageous in a number of applications, such as in the aforementioned instrumental panels and dashboard applications. The touch sensors 14-16 are commonly available features that measurably react to interferences in a manner in that a signal sensor or other feature may detect and communicate to the microprocessor for analysis, as described below in more detail.

The use of inner and outer touch sensors 14-16 is an optional feature which may be used to enhance sensitivity to changes in capacitance or other property changes in the touch sensors relied upon to assess user interaction with the touch pad. In more detail, the use of multiple touch sensors 14-16 allows the microprocessor to contrast signals from each of the touch sensors 14-16 in order to filter out or otherwise ameliorate environmental, ambient, and other interferences from unduly influencing sensor sensitivity. Of course, the present invention is not limited to touch pads 10 having multiple touch sensors and fully contemplates the use of a single touch sensor in sensing switch activation.

A dielectric layer 18 may be include to separate the touch sensors 14-16 and lighting feature 12 from an electrode 20. The dielectric 18 may comprise a material suitable to facilitate operations associated with the present invention. A covering layer 24 may be include to protect the other features of the touch pad 10 and to provide aesthetic designs. The covering layer 24 may be clear, colored, or decorated plastic or other suitable material. Optionally, the material thicknesses may be selected and configured to support low-profile operations such that a thickness of the entire touch pad is relatively thin.

The lighting feature 12 may be configured to share an electrical connection with one or more of the touch sensors 14-16. As shown, the lighting feature 12 shares an electrical connection with the inner touch sensor 14 such that lighting feature 14 and the touch sensor 14 are an integrated feature having a common conductive node and geographic position. In contrast, the outer touch feature 16 is not integrated with the lighting feature 12 as the two elements do not share a common conducting node.

FIG. 3 illustrates a schematic diagram 30 of an arrangement for sensing activation of first and second touch pads 32-34 in accordance with one non-limiting aspect of the present invention. The arrangement may be used with the touch pad 10 illustrated in FIGS. 1 and 2 or with other similarly configured touch pads where the lighting feature and at least one touch sensor share a common electrical connection. Different reference numerals are used in FIG. 3 to refer to features mentioned above with respect to FIGS. 1 and 2, however, this is not intended to limit the scope and contemplation of the present invention and is only done for exemplary purposes.

A first and second lighting feature 38-40 and first and second touch sensors 42-44 may be included and configured to share a common electrical connection at a their respective nodes 46-48. Third and fourth touch sensors 52-54 may be included to correspond with outer touch sensors (see FIGS. 1 and 2) associated the first and second touch sensors 42-44.

First and second sensing features 58-60 may be include to communicate with the microprocessor (not shown). The sensing features 58-60 may be configured to sample signaling at the nodes 46-48 shared by the touch sensors 42-44 and lighting sources 38-40 and to communicate the signal to the microprocessor for processing, and/or optionally, it may be configured to process the signals and to output corresponding information to the microprocessor for further processing.

Third and fourth sensing features 62-64 may be include to communicate with the microprocessor. The sensing features 62-64 may be configured to sample signaling associated with the outer touch sensors 52-54 and to communicate the signals to the microprocessor for processing, and/or optionally, it may be configured to process the signals and to output corresponding information to the microprocessor for further processing. The third and fourth sensing features 62-64 are shown to be substantially isolated from the first and second sensing features 58-60 as there is, optionally, no electrical connection between the third and fourth sensing features 62-64 and the lighting features 38-40 and other touch sensors 58-60.

The microprocessor may be configured to process one or more of the signals from the sensing features 58-64 and to determine activation of the corresponding touch pad 32-34 as a function thereof. The microprocessor may be further configured to correlate the activation of the touch pads 32-34 with other switching operations and applications to facilitate control of any number of systems and subsystem associated therewith.

For example, the touch pads 32-34 may be used in automotive instrument panels or dashboard applications wherein switching operations are desired for changing radio stations, setting climate control options, speed control, vanity mirror illumination control, door lock control and performing a number of other operations. The microprocessor may be corresponding configured to control and interpret activation of the touch pages to facilitate particular operation associate therewith.

A power source 66 may be included to drive one or more of the touch pads 32-34. The power source 66 may be configured to emit signals suitable for driving the lighting features 38-40 associated therewith. For example, if the lighting features 38-40 are EL lights, the power source 66 may be an alternating current (AC) power source configured to drive the EL lighting features at a low frequency signal, within the range of 50-1000 hz, and typically between 100-200 hz. As shown, the power source 66 is used to drive both lighting features 38-40, however, the present invention is not so limited and fully contemplates to use of multiple power sources and the use of a power source for each lighting feature 38-40.

The ability of the first and second sensing features 58-60 to precisely measure changes in capacitance of the touch sensors 42-44 can be influenced by interferences associated with the power source 66. First and second transformers 68-70 may be associated with the first and second touch pads 32-34 to isolate the power source 66 from the first and second sensing features 58-60.

The transformers 68-70 may be used isolate one touch pad 32-34 from the other as well as to isolate the power source 66 for each touch pad 32-34 from the power source 66. The isolation between the two touch pads 32-34 can limit actions or operations on one touch pad 32-34 from negatively influencing operations on the other touch pad 32-34. The isolation of the power supplies can limit power from the power source 66 from interfering with lower voltage signals used by the sensor features 58-64 to detect activation of the touch sensors.

The sensing features 58-64 may be configured to emit signals to the touch sensors 42-44 and 52-54 associated therewith to facilitate monitoring changes in the capacitance thereof. The first and second sensing features 42-44 may be configured to emit high frequency signals to the nodes 46-48 such that the high frequency signals are superimposed over the low frequency signals used to drive the lighting features 38-40.

The contrast between high and low frequency signals may be advantageous in enhancing sensor sensitivity to changes in the first and second touch sensors 42-44. A higher frequency is utilized to provide quick response times. For conventional capacitive technology, hundreds or thousands of pulses are required to detect a single touchpad, or many individual readings can be averaged for a single reading.

Each touch pad 32-34 may further include a low pass filter 74-76 to further enhance sensitivity of the sensing features 58-60 to changes in the first and second touch sensors 42-44. The low pass filters 74-76 may be resistor-inductor (RL) low pass filters. The filters 74-76 essential act as an open to the high frequency signals to prevent the high frequency signal from traversing the lighting source 38-40, and the filters 74-76 essential act as a short to the low frequency signals to effectively control the lighting features 38-40 and limit the low frequency signal from interfering with the ability of the sensing 58-60 features to sense the high frequency signals.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of determining switch activation for an integrated touch pad having a touch sensor and lighting feature, the method comprising:
actively driving the lighting feature; and
sensing activation of the touch pad without interrupting driving of the lighting feature.

2. The method of claim 1 further comprising monitoring capacitance associated with the touch sensor and determining activation of the touch pad as a function thereof.

3. The method of claim 1 further comprising driving the lighting feature with a low frequency signal and superimposing a high frequency signal thereover for use in sensing activation of the touch pad.

4. The method of claim 3 further comprising exposing the lighting feature and touch sensor to a low pass filter in order to limit interference with the high frequency signal.

5. The method of claim 4 further comprising configuring the low pass filter to be a RL low pass filter.

6. The method of claim 1 further comprising isolating a power source associated with driving the lighting feature from the lighting source and touch sensor so as to limit interferences in sensing activation of the touch pad.

7. The method of claim 6 further comprising providing a transformer for isolating the power source from the lighting source and touch sensor.

8. The method of claim 1 further comprising providing an additional touch sensor and sensing activation of the touch pad as a function of signals associated with both touch sensors.

9. A method of determining switch activation for an integrated touch pad having a touch sensor and lighting feature, the method comprising:
driving the lighting feature with a low frequency signal;
providing a high frequency signal to the touch sensor; and
sensing activation of the touch pad as a function a capacitance change sensed with the high frequency signal.

10. The method of claim 9 further comprising superimposing the high frequency signal over the low frequency signal.

11. The method of claim 9 further comprising filtering the low frequency signals relative to the high frequency signal to limit interference when sensing activation of the touch pad.

12. The method of claim 9 further comprising isolating a power source associated with driving the lighting feature with the low frequency signal from the lighting source and touch sensor so as to limit interferences in sensing activation of the touch pad.

13. A touch pad system, the touch pad system comprising:
a lighting feature configured to emit light when driven;
a touch sensor configured to share a common electrical connection with the lighting feature such that the lighting element and touch sensor form an integrated lighting feature and touch sensor;
a logical element to determine activation as a function of signals associated with the touch sensor; and
a feature to limit interference associated with driving of the lighting feature from unduly influencing sensing activation of the touch sensor.

14. The touch pad system of claim 13 wherein the feature is a filter configured to isolate a first signal used to drive the lighting feature from a second signal used to facilitate determining activation of the touch pad.

15. The touch pad system of claim 14 wherein the filter is a low-pass RL filter.

16. The touch pad system of claim 13 wherein the feature is configured to isolate a power source used to drive the lighting feature.

17. The touch pad system of claim 16 wherein the feature is a transformer.

18. The touch pad system of claim 13 further comprising an additional touch sensor for use in determining activation as a function of influences on both touch sensors.

19. The touch pad system of claim 13 further comprising an automotive module in communication with the logical element and configured to be controlled according to signals received from the logical element in response to activation of the touch pad.

20. The touch pad system of claim 19 further comprising a decorative cover to facilitate mounting to a dashboard of an automobile having the automotive module.
